(19) United States
(12) Patent Application Publication
(10) Pub. No.: US 2009/0195158 A1
(43) Pub. Date: Aug. 6, 2009

(54) Short arc type high-pressure discharge lamp

(75) Inventors: Nobuhiro Nagamachi, Hyogo (JP); Toyohiko Kumada, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/320,612

(22) Filed: Jan. 30, 2009

(30) Foreign Application Priority Data
Feb. 4, 2008 (JP) 2008-023665

(51) Int. Cl. H01J 61/04

(52) U.S. Cl. 313/631

(57) ABSTRACT

In a light emission portion of a short arc type high pressure discharge, a pair of electrodes, each of which has a block portion at a tip thereof, is provided, wherein a pseudo coil area made up of ring-like portions is formed in part of the block portion, and an unprocessed area whose diameter is approximately the same as that of the pseudo coil area is formed in a back side of the pseudo coil area.

### CROSS-REFERENCES TO RELATED APPLICATION

This application claims priority from Japanese Patent Application Serial Nos. 2008-023665 filed Feb. 4, 2008, the content of which is incorporated herein by reference in its entirety.

### TECHNICAL FIELD

The present invention relates to a short arc type high pressure discharge lamp. The present invention especially relates to an extra-high pressure discharge lamp, in which 0.15 mg/mm³ or more of mercury is enclosed in an arc tube thereof and the mercury vapor pressure at time of lighting becomes 110 or more of atmospheric pressure, and which is used as a light source for a projector apparatus, such as a DLP (digital light processor) apparatus using a liquid crystal display apparatus or a DMD (digital mirror device) etc.

### BACKGROUND

A projection type projector apparatus requires uniform image illumination with sufficient color rendering properties to a rectangle screen. Therefore, a lamp in which 0.15 mg/mm³ or more of mercury is enclosed so as to obtain high mercury vapor pressure, is used as a light source.

Such a lamp includes a pair of electrodes which are arranged so as to face each other at an interval of 2 mm or less in the arc tube made of quartz glass. In this arc tube, 0.15 mg/mm³ or more of mercury and halogen in a range of 1×10⁻⁶ to 1×10⁻² μmol/mm³ is enclosed. Although the main purpose of enclosing the halogen is to prevent devitrification of the arc tube, this causes the so-called halogen cycles. Moreover, the so-called melted electrode, which is made by winding a coil around an axis rod and melting the coil, is used therefor.

FIG. 7 shows a schematic view of the structure of a short arc type high-pressure discharge lamp having such a melted electrode. A coil is winded around a tungsten rod so as to make an electrode. A tip of the electrode is formed so as to be a block shape by melting only the tip portion of the coil. A back end of the electrode remains as a remaining portion of the coil. The coil causes glow discharge according to a surface concavo-convex effect at time of a lamp lighting start-up, so as to function as a start-up source thereof (starting position). After the beginning of lighting, when the discharge continues with the temperature rise of the coil, the glow discharge turns into arc discharge. This type of an electrode structure is disclosed in Japanese Laid Open Patent No. 2004-247092.

On the other hand, in recent years, an output of a discharge lamp used for such a purpose is progressively increased, and electric power (current) applied to the lamp is also increased. Since the increase of applied current makes the temperature of the electrode high, more measures against the temperature rise is required in order to use it as a lamp. On the other hand, miniaturization is increasingly required in an apparatus such as a projector apparatus having a lamp, so that miniaturization of the lamp which is a light source thereof is strongly called for. That is, such a discharge lamp must be miniaturized, while the demands of a high output thereof and the measures against high temperature of the electrode are fulfilled. Here,.as the measure against high temperature, the volume of an electrode may be increased so as to increase the heat capacity thereof. However, if the size of the electrode becomes large, the discharge lamp must be made from an unprocessed glass pipe having a large inner diameter, so that the outer diameter of the sealing portions of the discharge lamp also becomes large, and the increase in the size is contradictory to the demand of the miniaturization.

Moreover, a technology is known in which a “pleat” like heat release portion formed by cutting raw material thereof, is used, instead the melted electrode described above. Since no coil is winded around the main body of the electrode, the size thereof can be made small as a whole. However since the “pleat” portion and the electrode axis portion are formed so as to be integrally connected to each other so that heat is released through the electrode axis portion, the temperature of the “pleat” like heat release portion does not rise so much. That is, even if glow discharge occurs in the “pleat” like heat release portion, since the temperature rise of the “pleat” like heat release portion may not progress after that, there is a problem that it cannot shift to arc discharge. Such an electrode structure is disclosed in Japanese Laid Open Patent No. 2007-265624.

### SUMMARY

It is an object of the present invention is to offer a short arc type high-pressure discharge lamp having an electrode structure which is high-temperature-tolerant and high-input tolerant, while it has a good lighting property.

One of the aspects of the present invention is a short arc type high pressure discharge lamp, in which 0.20 mg/mm³ or more of mercury and halogen are enclosed in a light emission portion, comprising a pair of electrodes, each of which has-a block portion at a tip thereof, wherein a pseudo coil area made up of two or more ring-like portions is formed in part of the block portion, and an unprocessed area whose diameter is approximately the same as that of the pseudo coil area is formed in a back side of the pseudo coil area.

In the short arc type high pressure discharge lamp 80% or more of an outer surface of the ring-like portions is physically separated from the block portion.

The ring-like portions may be physically separated from the block portion.

The pseudo coil area may be formed by irradiating laser light on the block portion.

Another aspect of the present invention is a method of producing a short arc type high pressure discharge lamp, wherein 0.20 mg/mm³ or more of mercury and halogen are enclosed in a light emission portion, and a pair of electrodes facing each other at an interval of 2.0 mm, each of which has a block portion at a tip thereof, is arranged in the light emission portion. The method comprises the following steps of irradiating laser light on an outer surface of the block portion so as to form grooves having a minute gap, relatively moving the block portion in a circumferential direction with respect to the laser light so as to form a ring-like portion in the circumferential direction, and moving the block portion in an axis direction of the block portion thereby forming another ring-like portion in the axis direction of the block portion.

In the above mentioned structure according to the present invention, first of all, the ring-like member functions similarly to a coil, so as to have a good lighting property. That is, since the ring-like member is provided so as to be physically separated from the electrode as another component, or since the ring-like member is connected only to a far end portion of the electrode block portion, a high temperature state can be maintained without decreasing the temperature even after glow discharge occurs. Secondly, while the ring-like member is provided at a front area of the electrode block portion, i.e. in the side of the electrodes facing each other, since the cylinder section has an outer diameter which is approximately equal to the outer diameter of the ring of the ring-like member in a back area of the electrode block portion, it is possible to make the electrode structure having large heat capacity, without using a large unprocessed pipe from which a lamp is made.

### BRIEF DESCRIPTION OF DRAWINGS

Other features and advantages of the present short arc type high-pressure discharge lamp will be apparent from the ensuing description, taken in conjunction with the accompanying drawings, in which:

FIG. 1 shows a short arc type discharge lamp according to the present invention;

FIG. 2 shows a schematic view of the structure of an electrode of a short arc type discharge lamp according to the present invention;

FIG. 3 shows a schematic view of the structure of an electrode of a short arc type discharge lamp according to the present invention;

FIG. 4 shows a schematic view of the structure of an electrode of a short arc type discharge lamp according to the present invention;

FIG. 5 shows a schematic view of the structure of an electrode of a short arc type discharge lamp according to the present invention;

FIG. 6A shows the entire electrode structure;

FIG. 6B is an enlarged view of 6B shown in FIG. 6A; and

FIG. 7 shows a conventional short arc type discharge lamp.

### DETAILED DESCRIPTION

A description of embodiments of the present short arc type high-pressure discharge lamp will now be given below, referring to drawings. While the claims are not limited to such embodiments, an appreciation of various aspects of the present short arc type high-pressure discharge lamp are best gained through a discussion of various examples thereof.

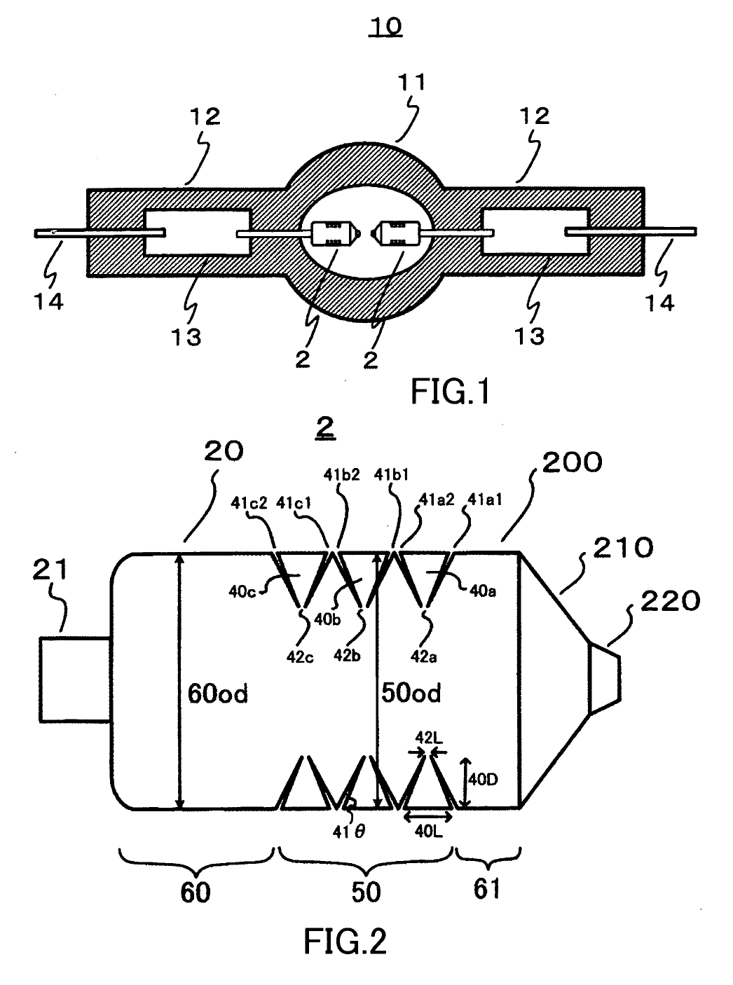

FIG. 1 shows the entire structure of a short arc type extra-high pressure discharge lamp (hereinafter referred to as a discharge lamp) according to the present invention. A discharge lamp 10 has an approximately spherical shape light emission section 11 made from a quartz glass electric discharge container. A pair of electrodes 2 is arranges so as to face each other, in the light emission section 11. Sealing portions 12 are formed at both ends of the light emission section 11 so as to extend from the light emission section 11. In general, metallic foils 13 for electric conduction made of molybdenum are airtightly buried in the respective sealing portions 12 by, for example, shrink sealing. Axis portions of the pair of electrodes 2 are electrically connected to the respective metallic foils 13. Moreover, an external lead 14 which projects outside the discharge lamp is connected to the other end of each metallic foil 13.

Mercury, rare gas, and halogen gas are enclosed in the light emission section 11. The mercury whose amount is 0.15 mg/mm³ or more is enclosed the light emission section 11 to obtain radiation light having the required visible light wavelength of, for example, 360-780 nm. Although depending on temperature conditions of the light emission section 11, with the enclosed amount of the mercury, the vapor pressure thereof becomes extremely high at time of lighting, that is, 150 or more atmospheric pressure. Moreover, by enclosing more mercury, it is possible to make a discharge lamp whose mercury vapor pressure is higher at time of lighting, such as 200 or more atmospheric pressure or 300 or more atmospheric pressure. The higher the mercury vapor pressure becomes, the more a light source for a projector apparatus is suitably realized. Argon gas as the rare gas whose amount is, for example, 13 kPa is enclosed in the light emission section 11, so as to improve the lighting starting nature. The halogen, such as iodine, bromine, chlorine, etc. is enclosed in form of a compound with mercury or other metals. The amount of enclosed halogen is chosen in a range of 10⁻⁶ to 10⁻² μmol/mm³. Although the function thereof is for long-life which is attributed to the halogen cycle, in case the discharge lamp is very small as in the present invention and the inner pressure thereof is extremely high, such halogen is mainly used to prevent devitrification of the electric discharge container.

An example of specification of the discharge lamp will be given below. For example, the maximum outer diameter of the light emission section is 9.5 mm, a distance between the electrodes is 1.5 mm, and the arc tube internal volume is 75 mm³, rated voltage is 80 V, and rated power is 150 W, and lighting is carried out with alternating current. Moreover, since this type of discharge lamp is built in the projector apparatus to be miniaturized, and high light intensity is required while the overall dimension of the apparatus is extremely miniaturized, thermal influence in the arc tube portion becomes very severe. The lamp tube wall load value is set to 0.8-2.0 W/mm², and specifically to 1.5 W/mm². When the discharge lamp in which the mercury vapor pressure and the lamp tube wall load value are high is installed in an apparatus for presentation such as a projector apparatus or an overhead projector, it is possible to obtain radiation light with good color rendering properties.

FIG. 2 shows an enlarged view of the structure of an electrode 20. The electrode 2 comprises a block portion 20 which is formed at the tip of the electrode 2, and an axis portion 21. The block portion 20 and the axis portion 21 are physically separated parts from each other. The axis portion 21 is inserted in an insertion hole provided in the block portion 20. The block portion 20 is made up of a body portion 200, a taper portion 210, and a projection portion 220. These portions are physically formed of a single member, that is, the body portion 200, the taper portion 210, and the projection portion 220 are formed by cutting single raw material. The body portion 200 is cylindrical as a whole, and a pseudo coil area 50 which is described below is formed in an outer surface of the body portion. A ring-like portion area 40 (ring-like portions 40a, 40b, 40c) is formed in the pseudo coil area 50. When a side of the other electrode is referred to as a front side, and the other side, that is a side of the electrode axis portion 21 is referred to as a back side, the unprocessed area 60 is formed in a back side of the body portion 200. Moreover, in this embodiment, a front unprocessed area 61 is formed in the front side of the pseudo coil area 50, i.e., in a side of the other electrode which the electrode 2 faces.

The taper portion 210 is formed in a front side of the body portion 200, and has an approximately circular truncated cone shape as a whole, and the outer diameter of the taper portion 210 in the base side thereof is equal to that of the body portion 200. The projection portion 220 is formed in the front side of the taper portion 210 and is a small projection having a circular truncated cone shape or a cylindrical shape. In an alternating current lighting lamp, at the projection portion 220, an arc is formed, so that the temperature thereof becomes highest. In addition, although the projection portion 220 may be formed together with the block portion 20 when performing cutting work to form the block portion 20, it may be automatically formed with progress of lighting time, in a lamp in which halogen is enclosed.

The block portion 20 is made of tungsten whose purity is, for example, 4N or higher. This is because if impurities are contained therein, they adhere to the arc tube so as to exert a bad influence thereon. The dimension of the respective parts is shown for convenience of explanation in the figures. An example of specification thereof is described below. The outer diameter of the body portion 200 of the block portion 20 is φ 1.0-3.0 mm, for example, 1.5 mm, and the length thereof in the axial direction is 2.0-5.0 mm, for example, 3.6 mm. The outer diameter at a tip of the taper portion 210 is φ 0.2-1.0 mm, for example, 0.5 mm, and the length thereof in the axial direction is 0.5-3.0 mm, for example, 0.7 mm. The length in the axial direction of the projection portion 220 is 0.1-0.9 mm, for example, 0.2 mm. Moreover, the outer diameter of the axis portion 21 is φ 0.3-1.0 mm, for example, 0.4 mm, and the length thereof in the axial direction is 0.5-3.0 mm, for example, 1.5 mm. The length of the axis portion 21 is 1.6 mm and is inserted in the block portion 20.

The ring-like portion area 40 (ring-like portions 40a, 40b, 40c) is formed by processing part of the body portion 200. Specifically, a groove portion 41 (comprising minute grooves 41a1, 41a2, 41b1, 41b2, 41c1, 41c2) is formed by irradiating laser light onto the cylindrical body portion 200. The grooves 41a1, 41b1, and 41c2 are formed by irradiating the laser light, aslant from the front side of the body portion 200 (the side of the projection portion 220). Moreover, the groove 41a2, 41b2, and 41c2 are formed by irradiating the laser light, aslant from the back side of the body portion 200 (the side of the axis portion 21). Therefore, these three ring-like portions (40a, 40b, 40c) are formed in the ring-like portion area 40 in the axial directions of the block portion 20 in this embodiment. Specifically, the ring-like portion 40a formed by the groove 41a1 and the groove 41a2, the ring-like portion 40b formed by the groove 41b1 and the groove 41b2, and the ring-like portion 40c formed by the groove 41c1 and the groove 41c2, are sequentially formed from the side of the projection portion 220.

Thus, the grooves are formed aslant from the outer surface of the electrode to the inner portion thereof, by irradiating the laser light aslant from both the front and back directions to one part. As a result, the shape of each ring-like portion in the ring-like portion area 40, is approximately a triangle in a cross sectional view of the electrode taken along the axis of the electrode. Moreover, in this embodiment, since the laser light is irradiated while rotating the body portion 200 about the axis portion, the grooves are formed throughout the circumference of the body portion 200 in a circumferential direction.

The ring-like portion 40a is formed of the groove area 41a2 formed throughout the circumferential direction and the groove 41a1 formed throughout the circumferential direction. Although it is integrally connected with the body portion 200 in an area 42, most of the outer surface of the ring-like portion 40a is physically separated from the body portion 200 (block portion 20). In such a structure, the ring-like portions are formed like a coil.

The pseudo coil area 50 is an outer surface area of the body portion 200, and the ring-like portion area 40 (where the ring-like portions 40a, 40b, 40c are formed). Moreover, the unprocessed area 60 is an outer surface of the body portion 200 and an area other than the ring-like portion area 40 (the ring-like portions 40a, 40b, 40c are formed), that is, an unprocessed area formed in the back side of the pseudo coil area 50. In addition, the unprocessed area formed in the front side of the pseudo coil area 50 is referred to as the front unprocessed area 61.

After a glow discharge occurs in the ring-like portion area according to the present invention, the temperature of the ring-like portions hardly falls. This is because since most of the outer surfaces of the ring-like portions are physically separated from the body portion (block portion) like separate components, even after the glow discharge occurs in the ring-like portion area, the high temperature state can be maintained in the ring-like portion area, without temperature fall.

Moreover, in the electrode structure according to the present invention, since the electrode block portion is provided in an area in a relatively front side of the ring-like portion, i.e., in a side of the other electrode which the electrode faces, and the unprocessed area 60 having an outer diameter 60od which is almost equal to an outer diameter 50od of rings of the ring-like portions is formed in an area in the back side of the electrode block portion, it is possible to offer an electrode with a large heat capacity without making a lamp large in size.

An example of specification (dimension) of the ring-like portion area 40 is given below. A length 40L in the axial direction in the triangle portion a cross sectional view is 0.1-0.4 mm, for example, 0.3 mm, a length (height) 40D in a depth direction of the triangle portion in the cross-sectional view is 0.1-0.4 mm, for example, 0.3 mm, and a length 42L of the area 42 which is integrally connected to the body portion 200 is 0.02-0.3 mm, for example, 0.05 mm. An angle 410 formed by the groove 41 and the body portion 200 as shown in FIG. 2 is 30-80 degrees, for example, 60 degrees. The width of each groove 41 on an outer surface of the body portion 200 is 0.02-0.15 mm, for example, 0.08 mm.

The number the ring-like portions 40 formed in the body portion is one to twenty (1-20), for example, three (3). The length of the pseudo coil area 50 in the axial direction of the body portion 200 is 1.0-3.0 mm, for example, 1.5 mm, and the length of the unprocessed area 60 in the axial direction of the body portion 200 is 5.0 mm or less, for example, 0.7 mm.

In the electrode shown in FIG. 2, an operation at time of lighting start-up is described below. In a state where no-load open circuit voltage is supplied between both electrodes, when high voltage for starting is impressed therebetween, dielectric breakdown occurs between the electrodes. With this dielectric breakdown, glow discharge is produced between the electrode 2 and the other electrode, where the minute gap of the groove 41 is a starting point. Although at the beginning, this glow discharge is very unstable, and is easy to vanish, it becomes stable as the temperature of the ring-like portion area 40 becomes high. When the electric discharge is stabilized, while the glow discharge gradually turns into the so-called arc discharge, the starting point of the arc discharge moves to the projection portion 220 where the temperature is the highest. After that, the arc discharge is maintained in which the projection portions 220 of the both electrodes are a starting point thereof.

Next, a method for forming the groove 41 in the block portion 20 will be described below. The electrode 2 (the block portion 20 and the axis portion 21) is attached to an electrode processing machine. While the electrode 2 is rotated at, for example, 500 rpm, laser light is irradiated for 30 seconds, thereby repeatedly irradiating the laser light on the same part about 250 times. The laser is a YVO4 solid laser and is irradiated at an average output of 8 W.

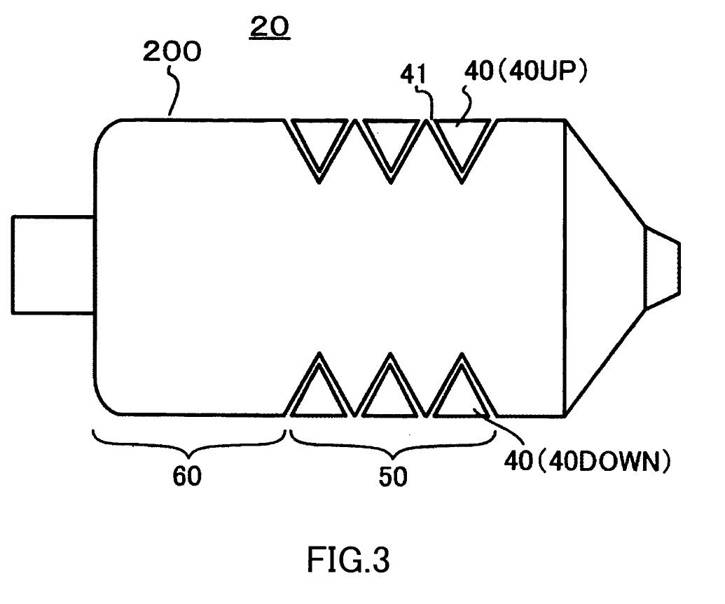

FIG. 3 shows another embodiment of an electrode according to the present invention. This embodiment is different from that shown in FIG. 2, in that a ring-like portions 40 are completely separated from a body portion 200 (the block portion 20), and there is no connecting area 42 shown in FIG. 2. The advantage of this structure, is that since a temperature fall of the ring-like portion 40 is small, that is, heat which is released through the body portion 200 (the block portion 20) due to heat conduction is small, it is possible to keep the temperature of the ring-like portions higher. In addition, since the ring-like portion 40 is completely physically separated from the body portion 200 (the block portion 20), when the discharge lamp is arranged, for example, horizontally, a portion (40UP) which is located in an upper side thereof, is brought into contact with the body portion 200 (the block portion 20) by the self-weight of the ring-like portion 40, and a portion (40DOWN) which is located in a down side thereof is moved in a direction where the ring-like portion 40 is away from the body portion 200 (the block portion 20) by the self-weight of the ring-like portion 40. Although the portion (40UP) which is located in the upper side is brought in contact with the body portion 200 (the block portion 20), the influence of heat release is smaller than that in the case where they are integrally formed. Moreover, when the entire ring-like portion is taken into consideration, the influence of the heat release as a whole is small since the area which is in contact with the body portion 200 is percentage-wise smaller than the area where they are not in contact with the body portion 200. In addition, in the present embodiment shown in FIG. 3, the contact of the ring-like portion with the body portion 200 (the block portion 20) is not taken into consideration, for convenience of explanation.

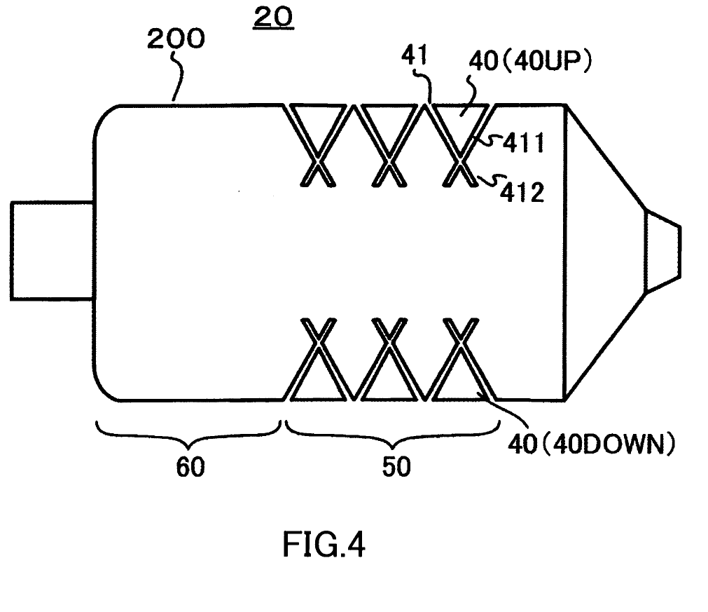

FIG. 4 shows still another embodiment of an electrode according to the present invention. A ring-like portion 40 is completely separated from a body portion 200 (a block portion 20), similarly to that shown in FIG. 3, and there is no connecting area 42 shown in FIG. 2. Furthermore, the structure shown in FIG. 4 differs from that shown in FIG. 3, in that grooves are formed in the inner portion of the body portion 200 beyond the ring-like portion 40. That is, the groove 41 comprises a groove 411 formed between the body portion 200 and the ring-like portion 40, and a groove 412 which is formed in the body portion 200.

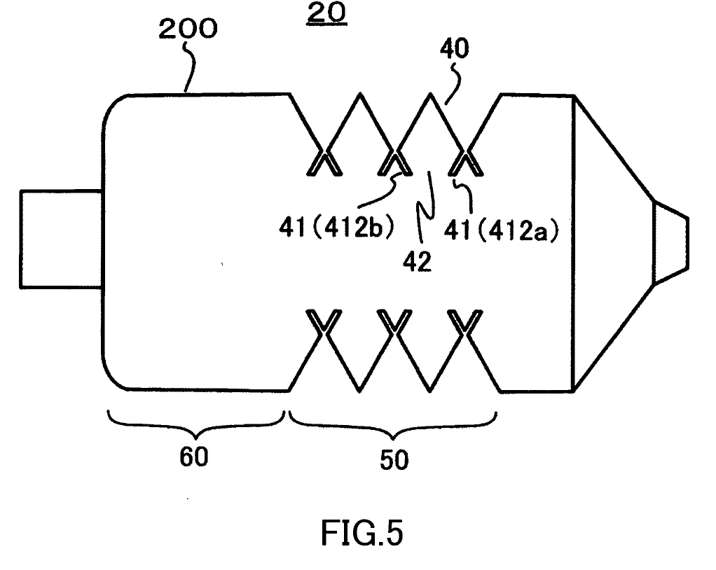

FIG. 5 shows still another embodiment of an electrode according to the present invention. Grooves are formed extending to a deep portion of a body portion 200, similarly to that shown in FIG. 4. The structure shown in FIG. 5 differs from that shown in FIG. 4, in that ring-like portions 40 whose shape is an approximately triangle in a cross sectional view of the electrode taken along an electrode axis are formed by grooves 41 (412a and 412b).

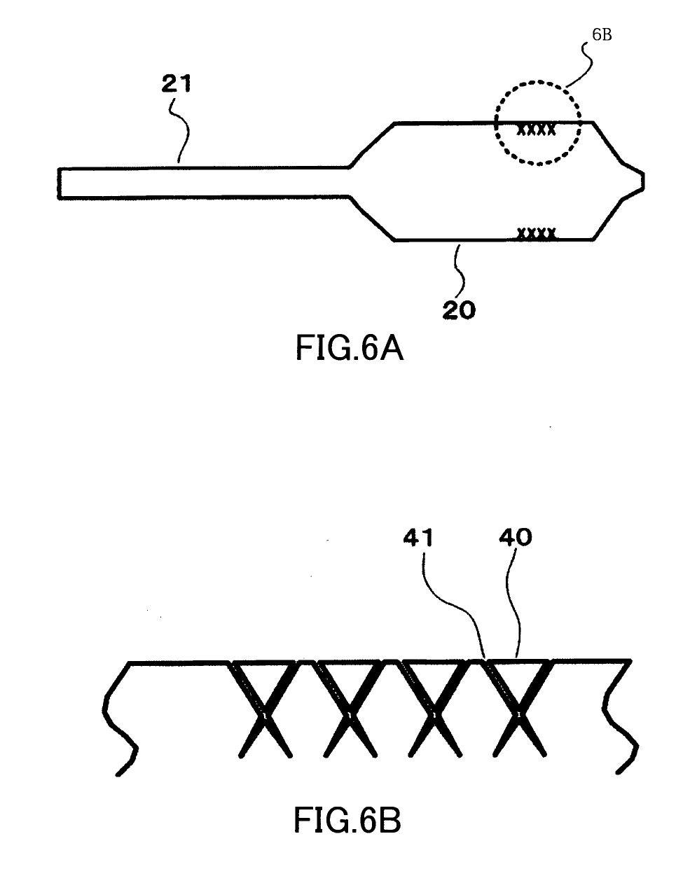

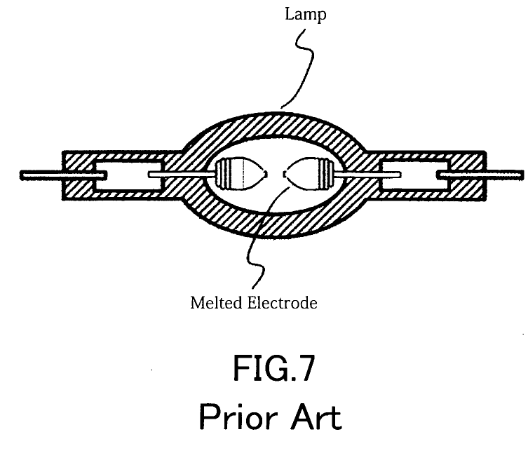

FIGS. 6A shows the same structure as the electrode structure shown in FIG. 4, wherein the entire structure including an electrode axis portion is shown, closely to the actual dimension. That is, although in FIG. 4, the electrode structure is shown for convenience of understanding so that the dimension thereof is not realistic, the structure in FIGS. 6A and 6B shows actual dimensional relationship of the grooves and the electrode. FIG. 6A shows the entire electrode structure, and FIG. 6B is an enlarged view of 6B shown in FIG. 6A.

First of all, since the present invention has the above-mentioned structure, the ring-like portion functions as a coil functions, thereby obtaining good lighting property. That is, since the ring-like portion is physically separated from an electrode so as to exist as a separate component from the electrode, or since it is connected to the block portion only at a far inner portion of an electrode block portion, it is possible to keep the temperature thereof high without decreasing the temperature even after glow discharge is generated. Secondly, while providing the ring-like portion at the front side of an electrode block portion, i.e., a side of the other electrode which the electrode faces, and it is has a cylinder section whose outer diameter is almost equal to the outer diameter of the ring of the ring-like portion in the back side of the electrode block portion, it is possible to form the electrode structure where heat capacity is large, without using a large unprocessed pipe to make a lamp.

The preceding description has been presented only to illustrate and describe exemplary embodiments of the present short arc type high-pressure discharge lamp according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A short arc type high pressure discharge lamp, wherein 0.20 mg/mm³ or more of mercury and halogen are enclosed in a light emission portion, comprising: a pair of electrodes, each of which has a block portion at a tip thereof, wherein a pseudo coil area made up of two or more ring-like portions is formed in part of the block portion, and an unprocessed area whose diameter is approximately the same as that of the pseudo coil area is formed in a back side of the pseudo coil area.

2. The short arc type high pressure discharge lamp according to claim 1, wherein 80 % or more of an outer surface of the ring-like portions is physically separated from the block portion.

3. The short arc type high pressure discharge lamp according to claim 1, wherein the ring-like portions are physically separated from the block portion.

4. The short arc type high pressure discharge lamp according to claim 1, wherein the pseudo coil area is formed by irradiating laser light on the block portion.

5. A method of producing a short arc type high pressure discharge lamp, wherein 0.20 mg/mm³ or more of mercury and halogen are enclosed in a light emission portion, and a pair of electrodes facing each other at an interval of 2.0 mm, each of which has a block portion at a tip thereof, is arranged in the light emission portion, comprising the following steps of:
irradiating laser light on an outer surface of the block portion so as to form grooves having a minute gap a pair of electrodes, each of which has a block portion at a tip thereof;
relatively moving the block portion in a circumferential direction with respect to the laser light so as to form a ring-like portion in the circumferential direction; and
moving the block portion in an axis direction of the block portion thereby forming another ring-like portion in the axis direction of the block portion.
